(19) United States
(12) Patent Application Publication
(10) Pub. No.: US 2006/0082166 A1
(43) Pub. Date: Apr. 20, 2006

(54) Patio door lock mechanism

(76) Inventor: Barry G. Lawrence, Thomasville, NC (US)

Correspondence Address: SUMMA, ALLAN & ADDITON, P.A., 11610 NORTH COMMUNITY HOUSE ROAD, SUITE 200, CHARLOTTE, NC, 28277, US

(21) Appl. No.: 11/110,265

(22) Filed: Apr. 20, 2005

Related U.S. Application Data
(60) Provisional application No. 60/563,928, filed on Apr. 21, 2004.

(51) Int. Cl. E05B 9/00

(52) U.S. Cl. 292/337

(57) ABSTRACT

The present invention relates to a locking mechanism, especially for sliding glass patio doors. The invention provides a locking device with improved strength and increased resistance to forced entry for new and existing sliding glass patio doors. The invention further provides a retrofit device to occupy a void or crevice in the lock mechanism such that force against the lock mechanism is distributed along adjacent parts.

### FIELD OF THE INVENTION

The present invention relates to an improved locking mechanism, especially for sliding glass patio doors.

### BACKGROUND

Glass patio doors have been used for many years in residential home construction. Glass patio doors are typically plate glass with a metal or plastic border on at least part of one edge of the glass. This border houses a lock mechanism. The lock mechanism engages a striker mounted in a metal or plastic door frame. Glass patio doors typically slide on bearings or rollers within a frame to achieve open and closed positions.

The structural characteristics of glass demand that locking mechanisms for glass patio doors be constructed differently than locks for wooden doors or steel doors. Doors constructed of wood or steel typically are at least 1½ inches thick. This thickness is sufficient to house the locking mechanism within the door. Sliding glass doors, however, are typically less than ½ inch thick, which is insufficient to house a robust internal locking mechanism of the kind typically found in standard wooden or steel doors. Constructing the sliding glass door to a comparable thickness as that of a typical wooden or metal door is impractical; the weight of the glass would be very difficult to slide even with the aid of bearings or rollers.

Consequently, locks for sliding glass patio doors are typically mounted in the metal or plastic border on one edge of the plate glass. In the closed and locked position, the lock engages a stationary metal or plastic striker mounted to a door frame surrounding the entire door.

Conventional sliding glass patio door designs maximize the area of glass used to construct the door to emphasize the aesthetic quality of glass. Unfortunately, this comes at a cost—security. As stated previously, the sliding glass patio door lock is housed in the marginal metal or plastic border of the plate glass. This border is constructed to preserve the maximum surface area of the glass and is not much thicker than the thickness of the plate glass.

Furthermore, the conventional design of glass patio doors allows for voids and crevices in critical areas around the lock mechanism. Consequently, the border does not allow for a robust locking mechanism such as that found in a hinged metal or wooden door. The conventional design permits the flexing, stressing, and eventual breakage of the lock mechanism. This weakness, at least in part, results in the targeting of sliding glass patio doors as access points for home invasions.

In addition, sliding glass patio doors are now required to pass more stringent testing for forced entry. Such increased security standards underscore the deficiencies in conventional sliding glass patio door lock design.

Thus, there is a need for an improved sliding glass patio door lock.

Furthermore, there is a need for an economical, easily installed retrofit device that increases the strength of the door lock mechanism and enhances security against forced entry for sliding glass patio doors already in use.

### SUMMARY OF THE INVENTION

It is an object of the present invention to provide a locking device with improved strength and increased resistance to forced entry for new sliding glass doors.

It is a further object of the present invention to provide an economical, easily installed retrofit device for a sliding glass door lock mechanism.

It is a further object of the present invention to provide a retrofit device to occupy a void or crevice in the lock mechanism such that force against the lock mechanism is distributed along parts adjacent to the lock mechanism.

### BRIEF DESCRIPTION OF THE DRAWINGS

FIG. 1 is a perspective view of a sliding glass patio door with an arrow pointing to the lock mechanism housing.

FIG. 2 is an exploded view of the conventional sliding glass door lock mechanism.

FIGS. 3a and 3b are sectional views of the current sliding glass door lock mechanism in the unlatched (FIG. 3a) and latched (FIG. 3b) positions.

FIGS. 4a and 4b are sectional views of the improved sliding glass door lock mechanism in the unlatched (FIG. 4a) and latched (FIG. 4b) positions.

FIG. 5 is a side view of a unitary hook reinforcing element for a sliding glass patio door, including the lock hook, reinforcing boot, mounting hole, and mounting ear.

### DETAILED DESCRIPTION

In one aspect, the invention is a sliding glass door assembly having an improved locking mechanism. The improved locking mechanism of the present invention provides increased resistance to forced entry.

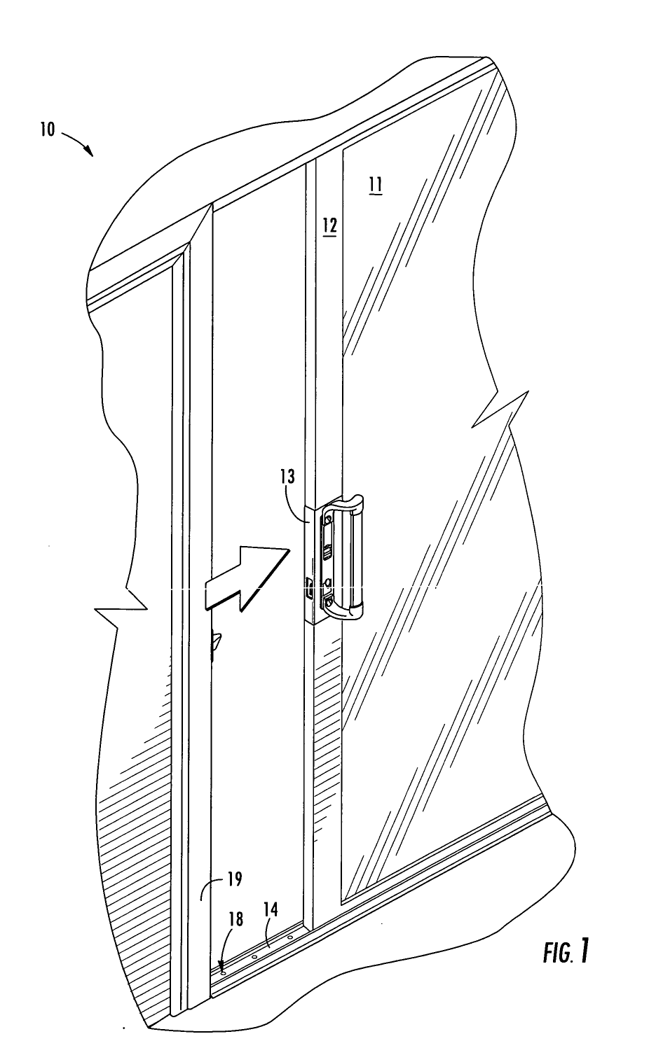

Embodiments of the present invention are depicted in FIGS. 1-5. It will be understood that the illustrations are for describing the typical embodiment of the invention and are not intended to limit the invention. Like numbers refer to like elements throughout the drawings and specification.

FIG. 1 depicts a sliding glass door assembly 10. The sliding glass door assembly 10 typically includes a sliding door 11 having a border 12 and a lock hook mechanism housing 13. The sliding door 11 slides between closed and open (arrow) positions within a U-shaped channel 14 (i.e., guide). The channel 14 may be part of the door frame 19, or may be a separate piece connected to the frame 19 with one or more fasteners 18 (e.g., a sheet metal screw). Other appropriate fasteners are known to those of ordinary skill in the art.

Referring to FIG. 2, a conventional sliding glass door lock mechanism is depicted. In a typical embodiment, the sliding door 11 includes a lock hook mechanism housing 13 within the sliding door border 12. The lock hook mechanism housing 13 includes a front plate 15 and a back plate 16, and may also include a handle 17. The handle 17 may be mounted to the lock hook mechanism housing 13 using one or more fasteners 18, such as a threaded screw.

Other appropriate fasteners are known to those of ordinary skill in the art. One-way screws and other tamper-resistant fasteners, such as those manufactured by Bryce Manufacturing, Inc., (Gilbert, Ariz., USA) are useful to resist forced entry. The unique head pattern of tamper-resistant fasteners serves to deter a person using standard tools from gaining entry through the sliding door 11 by disassembling the lock hook mechanism housing 13.

The handle 17 may be made of metal, wood, plastic, any combination thereof, or any suitable material known to those of ordinary skill in the art. In addition, the handle 17 may be coated with a soft, resilient material, such as foam rubber or the like. Coating the handle 17 serves at least three purposes. First, the handle 17 is safer in the event a person strikes the handle 17. Second, the handle 17 is softer to the touch and less prone to temperature extremes in hot or cold weather. Third, the handle 17 is more aesthetically pleasing. Alternatively, the handle 17 may be integrated with the lock hook mechanism housing 13.

The front plate 15 further includes a lock hook 20. The lock hook 20 may be moved upward or downward using a lock hook controller 21. Movement of the lock hook 20 engages or disengages the lock hook 20 with the striker 22. In a typical embodiment, the striker 22 is mounted to the sliding glass door frame 19 using one or more fasteners 18, such as a threaded screw.

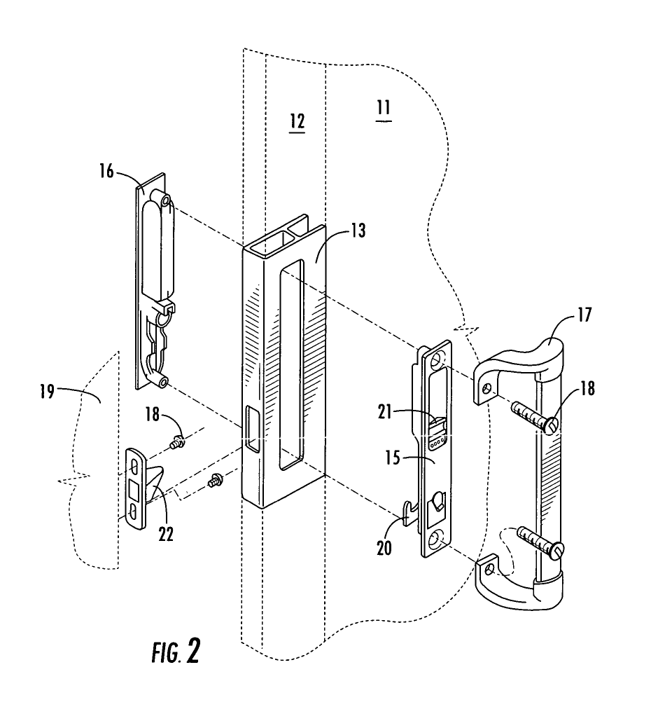

FIGS. 3a and 3b depict sectional views of the conventional lock hook mechanism housing 13 in the unlatched and latched positions, respectively. Shown in FIG. 3a, the lock hook mechanism housing 13 moves with the sliding door border 12 in the direction of the arrow toward the striker 22. Depicted in FIG. 3b, when the lock hook mechanism housing 13 reaches the striker 22, the lock hook 20 engages the striker 22 to close and lock the door (not shown).

Shown in FIGS. 3a and 3b, the lock hook 20 is mounted within the lock hook mechanism housing 13 using conventional and tamper-resistant mounting hardware, such as a bolt 23 and a nut 24. Other suitable mounting hardware is known to those of ordinary skill in the art. Furthermore, the lock hook mechanism housing 13 includes a mounting flange 25 to accommodate the lock hook 20. The conventional design generally shown and described in FIGS. 3a and 3b leaves a lock hook mechanism housing void 26 between the lock hook mechanism housing 13 and the front plate 15.

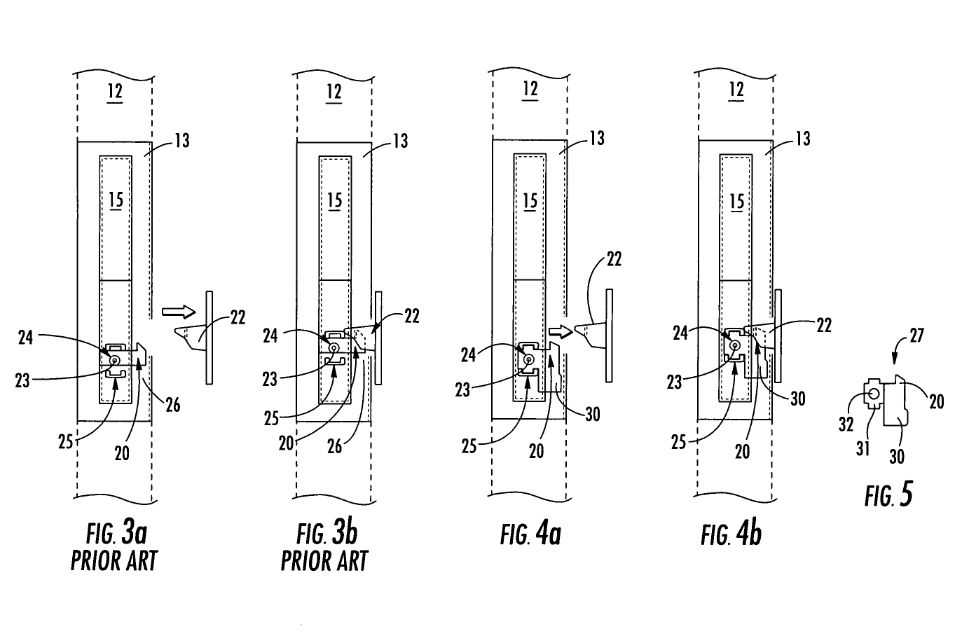

FIGS. 4a and 4b depict the improved sliding glass door lock mechanism of the present invention. In a typical embodiment, the lock hook 20 includes a reinforcing boot 30. The reinforcing boot 30 substantially fills the void 26 between the lock hook mechanism housing 13 and the front plate 15. Accordingly, the strength of the sliding glass door lock mechanism is improved in the closed and locked position.

In another aspect, the invention is a unitary hook reinforcing element 27 suitable as a retrofit device for existing patio door locks. Depicted in FIG. 5, the lock hook 20 and reinforcing boot 30 are a single piece of material constructed to fit existing lock hook mechanism housings 13. The unitary construction may include a mounting ear 31 to brace the mounting of the lock hook 20 and the reinforcing boot 30 within the mounting flange 25 of the lock hook mechanism housing 13. The unitary hook reinforcing element 27 may further include a mounting aperture 32 to accommodate standard mounting hardware, such as a bolt 23, nut 24, or other fastener known to those of ordinary skill in the art.

Thus, the unitary hook reinforcing element 27 of the present invention is suitable as a retrofit device for existing patio door locks. The unitary hook reinforcing element 27 of the present invention improves upon existing patio door locks by occupying a void 26 (see FIG. 3) in the lock hook mechanism housing 13. Thus, the strength of the sliding glass door assembly 10 is improved.

The lock hook 20 and reinforcing boot 30 may be made of plastic or metal material suitable for use in a sliding door border 12.

Plastic materials include, but are not limited to, fiberglass, fiberglass-reinforced nylon, glass-filled nylon, glass-filled polypropylene, polyester, and vinyl.

Metal materials include, but are not limited to, steel, titanium, brass, pewter, aluminum, or tin, or any alloys thereof. Furthermore, the metal material may be plated or coated to reduce its friction coefficient or to retard oxidation and corrosion. Substances suitable for this purpose include, but are not limited to, zinc, brass, bronze, or chrome.

The lock hook mechanism housing 13 of the present invention is designed to pass a Forced Entry Resistance Test for locking mechanisms. Briefly, the Forced Entry Resistance Test includes a five-minute disassembly sequence, a five-minute tool manipulation sequence, and a series of “pulls” to test the locking mechanism strength.

During the disassembly sequence, an operator attempts to access the lock mechanism by removing any protective covering (e.g., snap beads, weep hole covers, and Phillips or flat screws) from the exterior side of the sample within the allotted five-minute period.

During the hand and tool manipulation test, the operator has five minutes to manipulate the locking mechanism by hand and with basic tools (e.g., a wire and a putty knife).

Finally, the strength of the locking mechanism is tested using a series of “pulls.” Pulls exert force against the locking mechanism. The amount of force depends upon the rating (i.e., grade level) desired for a given locking mechanism. For example, the rating for a locking mechanism within a standard steel door would probably differ from the rating for a sliding glass door assembly of the present invention. The resisting force of the locking mechanism is measured with a dynamometer.

In the specification and the drawings, typical embodiments of the invention have been disclosed. Specific terms have been used only in a generic and descriptive sense, and not for purposes of limitation. The scope of the invention is set forth in the following claims.

1. A locking device for a sliding door, comprising a lock hook mechanism housing having a lock hook, said lock hook having a hook portion and a reinforcing boot portion, said reinforcing boot portion serving to brace said lock hook within said lock hook mechanism housing.

2. A locking device for a sliding door as in claim 1, further comprising a mounting flange integrated within said lock hook mechanism housing to accommodate said lock hook.

3. A locking device for a sliding door as in claim 2, further comprising a mounting ear that engages said mounting flange to brace the mounting of said lock hook and said reinforcing boot within said mounting flange.

4. A locking device for a sliding door as in claim 3, wherein said mounting ear further defines a mounting aperture to accommodate a fastener.

5. A sliding glass patio door assembly, comprising:
a substantially rectangular door frame;
a striker mounted to a vertical surface of said door frame; and
a door slideably mounted opposite said striker within said frame, said door comprising a border on one edge, said border comprising a lock hook mechanism housing, said lock hook mechanism housing comprising a locking device with a lock hook portion and a reinforcing boot portion;
wherein said door is in sliding communication with said frame and said striker;
wherein said locking device, in its closed and locked position, is in physical communication with said striker; and
wherein said reinforcing boot portion braces said lock hook within said lock hook mechanism housing.

6. A sliding glass patio door assembly according to claim 5, wherein said lock hook mechanism housing is affixed within said border.

7. A sliding glass patio door assembly according to claim 5, wherein said reinforcing boot portion braces said lock hook within said lock hook mechanism housing by occupying a void between said border and said lock hook mechanism housing.

8. A sliding glass patio door assembly according to claim 5, wherein said locking device comprises a mounting aperture for receiving a fastener.

9. A hook reinforcing element for a patio door locking device, comprising:
a lock hook comprising a hook portion, a reinforcing boot portion, and a mounting means for mounting said lock hook within a lock hook mechanism housing;
wherein said reinforcing boot portion distributes force against said lock hook to adjacent parts; and
wherein said mounting means comprises a mounting ear for securing within a mounting flange that is integrated within the lock hook mechanism housing.

10. A hook reinforcing element according to claim 9, wherein said reinforcing boot portion is mounted about said lock hook to brace said lock hook within said lock hook mechanism housing.

11. A hook reinforcing element according to claim 9, wherein said mounting means defines a mounting aperture for accepting a fastener.
